(19) United States
(12) Patent Application Publication
(10) Pub. No.: US 2008/0002185 A1
(43) Pub. Date: Jan. 3, 2008

(54) System and methods for non-destructive analysis

(76) Inventors: Anatoly Gitelson, Lincoln, NE (US); Mark Merzylak, Moscow (RU); Donald C. Rundquist, Lincoln, NE (US)

Correspondence Address: VALAUSKAS & PINE LLC, Suite 1825, 150 North Wacker Drive, Chicago, IL, 60606, US

(21) Appl. No.: 11/811,280

(22) Filed: Jun. 8, 2007

Related U.S. Application Data
(60) Provisional application No. 60/811,978, filed on Jun. 8, 2006.

(51) Int. Cl. G01N 21/00; G01N 21/55

(52) U.S. Cl. 356/73; 356/445

(57) ABSTRACT

A system and methods by which the state or condition of an object may be determined through the analysis of spectral bands. One embodiment of the present invention automatically detects a first spectral band having an absorption that is highly sensitive to the color of the object, such as that produced through a colorant or a pigment of interest. The embodiment then may automatically detect a second spectral band having absorption sensitive to color resulting from other colorants or pigments other than the pigment of interest. A third spectral band may also be automatically detected that is sensitive to reflective differences caused by variation in conditions. Subtracting the absorption in the first band by the second band and multiplying the result by the amount of light reflected in the third band results in the index. The index can be highly correlated with the concentration of the colorant of interest.

This application claims the benefit of U.S. Provisional Application No. 60/811,978 filed Jun. 8, 2006.

### FIELD OF THE INVENTION

The present invention relates generally to non-destructive analysis of objects, and in particular the present invention relates to analysis of objects based on coloration. Such coloration may be due to colorant or pigment.

### BACKGROUND OF THE INVENTION

Light striking an object can produce a number of effects including absorption, reflection, and transmission. Light is absorbed by the object, reflected by the object, or transmitted through the object. The amount of absorption, reflection, and transmission vary in accord with the wavelength and the characteristics of the illuminated object.

A variety of methods are known to determine the physical characteristics of an object. For example, there are many indices by which the physical characteristics of vegetation may be determined. These indices typically have limitations in the range of use, in their inherent accuracy, and in their dependence upon ancillary measurements. The Normalized Difference Vegetative Index (NDVI) is one of such indices. The NDVI is used to assess the percentage vegetative land cover in a plot or region. This index has an intrinsic error which increases at high levels of non-vegetated or vegetated area.

The physical characteristics of vegetation can be determined through the analysis of spectral signatures obtained through the use of known imaging spectrometers such as the AISA Eagle, and NASA's AVIRIS and through non-imaging sensors such as the Minolta Spad and the Ocean Optics Spectralradiometer. These spectra may be used to derive the indices described above or may be directly analyzed to determine some plant characteristic. In general, these instruments, however, are very complex and costly and use hundreds to thousands of wavelength bands in order to perform the analysis. While contact or near-contact instruments—such as the Minolta SPAD and Carter CMI 2000—measure chlorophyll content in leaves, they are not optimized for chlorophyll (and may have inherent errors) and cannot be used for a variety of pigments.

There is a demand for a highly accurate and simplified system and methods to determine many different colorants, such as vegetation and water quality characteristics, through the analysis of a small number of wavelength bands. For purposes of this application, a colorant shall be considered that which may provide color to an object and may be natural or added. Examples of colorants include dyes, natural pigments, pigment, inks, paint, or chemicals. The term colorant may be used interchangeably with the word pigment.

### SUMMARY OF THE INVENTION

For purposes of this application, the present invention is discussed in reference to colorants and pigments, or any material that produces the color of an object.

The present invention is a system and methods of non-destructive analysis to measure characteristics of an object. Characteristics include pigment concentration and composition in terrestrial systems or marine systems, such as individual plants, fields of crops, forests, lakes, reservoirs and rivers. Measuring these characteristics provides important information about the objects, such as their physiological and phenological status. The present invention can be used to provide other information such as vegetative stressors such as disease, drought, nutrient deficiencies (i.e., nitrogen), and whether bodies of water are clear or contain concentrations of foreign or natural substances or organisms including algae, including harmful ones.

The present invention relies on the principle that the concentration of a pigment or pigments in an object is indicative of its condition. Pigments include, for example, chlorophyll, anthocyanin, carotenoids, phycocyanin, and flavinoids. By knowing the concentration of one or more pigments in the object, for example a plant, the maturity of the plant, the extent the plant is experiencing stress, such as due to a lack of water or nutrients, and the extent to which the plant is diseased can be determined. The system and methods of the present invention facilitates the measurement of pigments in objects by the measurement of the reflected light in three relatively broad spectral bands. It is also contemplated that the present invention can facilitate the measurement of pigments in objects by measurement of the reflected light in two to five broad spectral bands.

A simplified embodiment of the present invention can determine the condition of an object through the analysis of two or three spectral bands.

In another embodiment, the system and methods then may automatically detect a third spectral band that is sensitive to reflective differences caused by variation in conditions that are of particular relevance to, for example, the object that is the subject of the analysis. For example, wherein the object is a leaf, these conditions include leaf thickness or density. The variation in conditions can further include substances such as dissolved organic mater, or physical characteristics such as object structure and surface properties of the object. Subtracting the absorption in the first band by the second band and multiplying the result by the amount of light reflected in the third band results in the index, or model value. The index is highly correlated with the concentration of the pigment of interest.

If the organism has pigments that weakly compete with the pigment of interest, the index may be determined through the use of only two wavelengths: the first and second spectral band since the second and third bands may be the same.

While one embodiment of the present invention uses two or three bands for single pigment measurement, other embodiments may measure multiple pigments simultaneously. For example, another embodiment of the present invention may analyze four spectral bands, such that chlorophylls, anthocyanins, and carotenoids may be measured simultaneously. Another embodiment can analyze a fifth band so that the concentration of phycocyanins or flavinoids may be determined.

One advantage of the system and methods of the present invention is that one embodiment includes a simple and inexpensive leaf-clip or close contact instrument that can nondestructively determine the concentration of pigments within objects such as leaves, fruit peel, and phytoplankton.

An additional advantage of the present invention is that because of the small number of wavelength bands needed and the relatively large bandwidth of those bands, the present system and methods will be generally cheaper to produce. The system of the present invention can be optimized for specific pigments causing a higher accuracy index and lower uncertainties.

Applications of the invention include determining the health and maturity of grain crops, wine grapes, forests, and grasslands. The technology described can help in detecting plant stress due to lack of water, nutrients, phosphorous, etc. It can help farmers and viticulturists determine the proper time to apply supplemental nutrients and to harvest the crop. Similarly, it can aid in predicting yield and fruit quality.

The present invention provides a generally highly accurate and simplified system and methods to determine many different pigments through the analysis of a small number of wavelength bands.

An index based on the reflectance of light at three specific wavelengths is determined such that the index value directly relates to the concentration of pigment in the object being observed. The index is computed in accord with the following equation which is the key element of the invention:
Index=[R(λ₁)⁻¹−R(λ₂)⁻¹]×R(λ₃) (1)
(the numbers in parentheses to the right of the equations in this application do not form a part of the equation but are provided for ease of reference.)

Identification of the wavelengths where the index value most accurately correlates with pigment concentration is accomplished through a step-wise refinement method. The principles are to identify a wavelength, represented by λ₁, where the reflectance, and hence the derived index, varies with the concentration of the pigment of interest as well as the concentrations of all other pigments and variation in conditions. Then a second wavelength, represented by λ₂, where the reflectance, and hence the derived index, varies with the concentrations of all pigments and conditions except the concentration of the pigment of interest. The inverses of the reflectances at these wavelengths, which are closely related to the absorbances at these wavelengths, are differenced. The result is a number which varies primarily just with the concentration of the pigment of interest. The reflectance at a third wavelength, represented by λ₃, is used to compensate for the amount of light reflection due to conditions, such as substances or physical characteristics of that which is producing the reflectance, not associated with pigments.

In the process of determining how the index and the actual pigment concentration relate, a linear equation is derived, the calibration equation, which allows the index value to be converted directly into a measurement of the concentration of the pigment of interest. This equation may be written:
Pigment Concentration=a+b[[R(λ₁)⁻¹−R(λ₂)⁻¹]×R(λ₃)] (2)

The actual values for “a” and “b” are established by determining the equation of the line relating pigment concentration to index value calculated in equation (1).

The three wavelengths are set to minimize the error between the points measured (index vs. concentration) and a straight line fit through those points. This linear regression process is repeated in a step-wise refinement to determine the three wavelengths and to identify the values for regression coefficients a and b. These wavelengths and the corresponding “a” value and “b” value are identified for each pigment to be measured.

The three optimal wavelength bands for certain pigments of interest, such as chlorophylls, carotenoids, and anthocyanins, are shown below:

| Pigment | λ₁ | λ₂ | λ₃ |
|---|---|---|---|
| Chlorophylls, Anth-free | 540-560 | 760-800 | 760-800 |
| Chlorophylls, Anth-free | 690-720 | 760-800 | 760-800 |
| Chlorophylls, Anth-cont | 690-720 | | 760-800 |
| Carotenoids | 510-520 | 540-560 | 760-800 |
| Carotenoids | 510-520 | 690-710 | 760-800 |
| Anthocyanins | 540-560 | 690-710 | 760-800 |

The optimal wavelengths, the a and b values for pigments of interest, and, where species dependent, the species to which they apply is retained in a storage device. The storage device may be incorporated and updated into an apparatus for measuring reflectance. Measurements of reflectance are taken at the optimal wavelengths to determine the value, or concentration, of the pigment of interest. While this description identifies specific wavelengths, the apparatus may also actually measure reflected light in a bandwidth of wavelengths surrounding the optimal wavelength. This is due to the physical and practical limitations of sensors and light sources. This practical bandwidth affects measurements in an insignificant way.

Another advantage is that through the use of simple and inexpensive apparatuses, such as spectral imaging devices—such as those that can be used at a distance, and on board a vehicle including a boat or an aircraft, a picture of pigment concentration, for example, within a wide area—such as an entire crop field—may be determined. Furthermore, the apparatus according to the present invention can be a hand-held device, mounted on a pole in a field, or satellite based. The apparatus according to the present invention is more generally applicable and more accurate than known apparatuses and systems.

The apparatus for measuring reflectance includes a light source, sensor and computational device. The apparatus is any imaging instrument, such as multispectral or hyperspectral. The light source may be a self-contained light source or an external light source such as the sun. It is also contemplated that the light source may be a plurality of light sources. A sensor may be a single sensor or a plurality of sensors, such as photo diodes, or photo transistors or photo resistors, to name a few. A computational device processes the reflectance to obtain the index or pigment concentration. The computational device, for example, can be a computer.

In one embodiment, the apparatus includes one light source, a plurality of sensors, and a computational device. This embodiment may further include optical filters, if needed. An optical filter may be needed if the optimization process indicates that the maximum bandwidth about the optimal wavelength is less than that provided by a light source or detector. The light source projects light onto the object of interest. The light source can be either internal or external. A plurality of sensors measures the reflectance at the optimal wavelengths. For example, there can be three sensors to measure reflectance at the first wavelength, second wavelength, and third wavelength. The reflectance measurements are sent to the computational device to obtain the pigment concentration. The computational device stores the data such as with the storage device of optimal wavelengths, regression coefficients (a) and (b) along with the species to which they apply. The computation device may also display the pigment concentration value. It is also contemplated that the apparatus may include two additional sensors to obtain different pigment concentrations.

In another embodiment, the apparatus includes a plurality of light sources, one sensor and a computational device. The plurality of light sources projects light onto the object sequentially. For example, a first light source is activated and the sensor measures the reflectance from the object. The first light source is deactivated and a second light source is activated and the sensor measures the reflectance from the object, and so on. The sensor measures the reflectance at the first wavelength, second wavelength and third wavelength for obtaining the pigment concentration from the computational device. Again, optical filters may be used.

Measurements of reflectance are taken by the apparatus by measuring a downwelling value and an upwelling value. The downwelling value is the range of wavelengths of light that impact onto the object. The projected light can be from all directions or at a specific angle. The upwelling value is the range of wavelengths of light coming off the object. Depending on application, the downwelling value and upwelling value can be obtained sequentially or simultaneously. Dividing the upwelling value by the downwelling value results in reflectance values for each wavelength of interest, or the optimal wavelengths. The index is then calculated based on the reflectance at the first wavelength, second wavelength and third wavelength. The index is then converted to a measure of the concentration of the pigment of interest.

The present invention and its attributes and advantages will be further understood and appreciated with reference to the detailed description below of presently contemplated embodiments, taken in conjunction with the accompanying drawings.

### BRIEF DESCRIPTION OF THE DRAWINGS

FIG. 1 illustrates a flow chart of an embodiment of the invention by which the index of a colorant such as a pigment of interest may be determined;

FIG. 2 is a flow chart of an embodiment of the measurements of reflectance taken by an apparatus according to the present invention; and

FIG. 3 is a flow chart of an embodiment of the measurements of reflectance taken by an apparatus according to the present invention.

### DETAILED DESCRIPTION OF EMBODIMENTS OF THE INVENTION

The present invention is a system and methods by which the state or condition of an object may be determined through the analysis of spectral bands. One embodiment of the present invention automatically detects a first spectral band having an absorption that is highly sensitive to the color of the object, such as that produced through a colorant or a pigment of interest. The embodiment then may automatically detect a second spectral band having absorption sensitive to color resulting from other colorants or pigments other than the pigment of interest. A third spectral band may also be automatically detected that is sensitive to reflective differences caused by variation in conditions. Subtracting the absorption in the first band by the second band and multiplying the result by the amount of light reflected in the third band results in the index. The index can be highly correlated with the concentration of the colorant of interest.

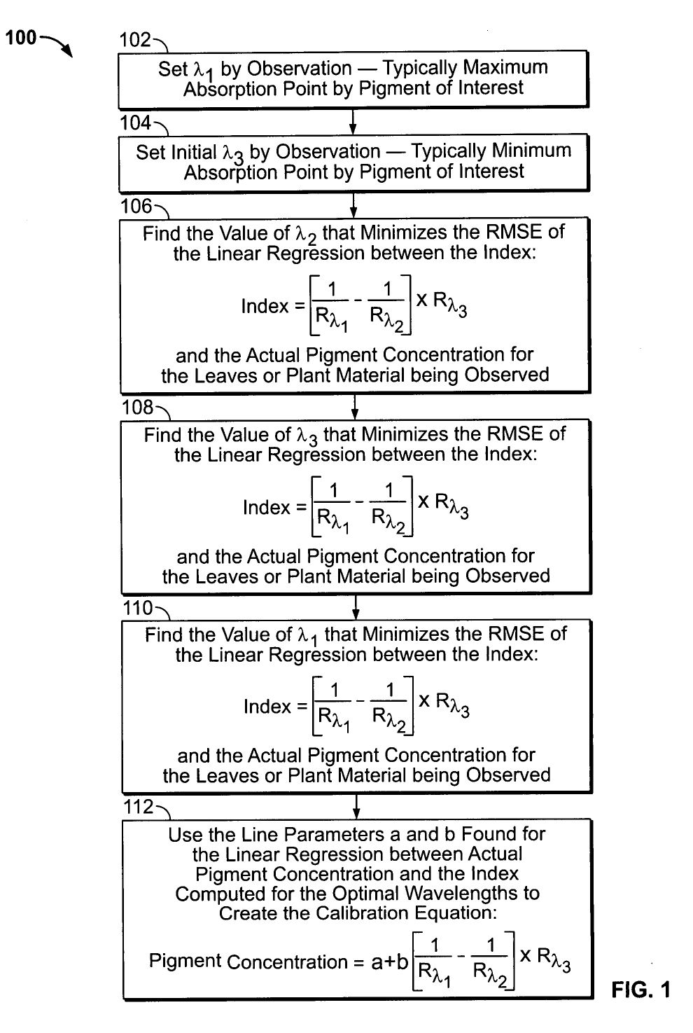

FIG. 1 illustrates a flow chart 100 of an embodiment of the invention by which the optimal wavelengths to be used in calculating an index value related to the concentration of a pigment may be determined. The purpose of the step-wise refinement method is to minimize the error in the linear regression between index values based on reflectance values measured at specific wavelengths and the actual concentration of the pigment in test samples. The equation for calculating the index is:
Index=[R(λ₁)⁻¹−R(λ₂)⁻¹]×R(λ₃) (1)

At step 102, an initial value for the first wavelength (λ₁) is established by identifying the wavelength of maximum absorption by the pigment of interest.

At step 104, the third wavelength (λ₃) is determined as a value that is approximately the maximum absorption by the pigment of interest.

At step 106, the wavelength value for the second wavelength (λ₂) is found which minimizes the root mean square error (“RMSE”) in the linear regression between the calculated index (1), with the initial values of λ₁ and λ₃ applied, and the actual concentration in the pigment of interest.

At step 108, the optimal value for the third wavelength (λ₃) is determined in an analogous manner by using the initial value of λ₁ and the value of λ₂ found in step 106.

At step 110, the optimal value for the first wavelength (λ₁) is identified also in an analogous manner by using the value of the third wavelength (λ₃) determined in step 108 and the value of the second wavelength (λ₂) found in step 106.

Finally, in step 112, the equation of the line found by linear regression when the three optimal wavelengths are used, provides the values of the parameters a and b allowing conversion of the index value into a measure of the actual concentration of the pigment of interest per the following equation:
Pigment Concentration=a+b[[R(λ₁)⁻¹−R(λ₂)⁻¹]×R(λ₃)] (2)

Following the steps of the flow chart according to FIG. 1, the following exemplifies determining the index for a chlorophyll pigment (Chl). As the first step, the optimal wavelength of λ₂ is found using an initial λ₁⁰=670 nm and λ₃⁰=760 nm. The root mean square error (RMSE) of chlorophyll estimation by the model (R₆₇₅⁻−R_{λ2}⁻¹)×R₈₀₀ provides minimal values at λ₂>760 nm for all species. Then, λ₂¹ was selected at 790 nm. Then, the optimal wavelength of λ₃ was found in the model (R₆₇₀⁻¹−R₇₉₀⁻¹)×R_{λ3}, with minimal RMSE. Then, the optimal wavelength of λ₁ was found in the model (R_{λ1}⁻¹−R₇₉₀⁻¹)×R₇₉₀. RMSE had two distinct minima: around 550 nm and around 690-725 nm. Therefore, two models can be used for chlorophyll estimation in anthocyanin-free leaves if the near infrared value (“NIR”) is set beyond 760 nm:
CHI_{green}∝[R₅₄₀₋₅₆₀⁻¹−R_{NIR}⁻¹]×R_{NIR}=(R_{NIR}/R_{green})−1 (3)
CHI_{red edge}∝[R₆₉₀₋₇₂₅⁻¹−R_{NIR}⁻¹]×R_{NIR}=(R_{NIR}/R_{red edge})−1 (4)

In anthocyanin-containing leaves, the first and second iterations provide the same results as for anthocyanin-free leaves: λ₂¹=λ₃¹=790 nm. However, in the third iteration, minimal RMSE was in the range only 690 to 725 nm. In the green range RMSE was maximal due to anthocyanin absorption. Thus, for chlorophyll retrieval from anthocyanin-containing leaves the equation (4) model should be used.

Following the steps of the flow chart according to FIG. 1, the following exemplifies determining the index for a carotenoid pigment (Car). Carotenoid content in crops and dogwood was related very closely (r²>0.97) with total chlorophyll content. As a result, carotenoid content cannot be treated as an independent variable. However, in tree species, such as beech, chestnut and maple, it was possible to estimate carotenoid content separately from chlorophyll content despite the quite close correlation between chlorophyll and carotenoid.

First, the optimal wavelength of λ₂ was found using an initial λ₁⁰=500 nm and λ₃⁰=760 nm. For all species, the RMSE using the (R₅₀₀⁻¹−R_{λ2}⁻¹)×R₇₆₀ model provided minimal values at λ₂¹=560-570 nm and around 700 nm. Subtraction of either R₅₆₀₋₅₇₀⁻¹ or R₆₉₀₋₇₁₀⁻¹ from R⁻¹(λ₁) significantly decreased the RMSE of the carotenoid estimation. For λ₂¹, 560-570 nm or 690-710 nm can be used. The optimal wavelength of λ₃ in the (R₅₀₀⁻¹−R₅₆₀⁻¹)×R_{λ3} and (R₅₀₀⁻−R₆₉₀₋₇₁₀⁻)×Rλ₃×Rλ₃ models was found in the NIR range beyond 760 nm. The, λ₃¹=790 nm was selected the optimal wavelength of λ₁ was found in the (R_{λ1}⁻¹−R₅₆₀₋₅₇₀⁻¹)×R₇₉₀ and (R_{λ1}⁻¹−R₆₉₀₋₇₁₀⁻¹)×R₇₉₀ at 510-520 nm. Thus, two models can be used for carotenoid estimation in anthocyanin-free leaves with NIR set beyond 760 nm:
Car_{green}∝[R₅₁₀₋₅₂₀⁻¹−R₅₆₀₋₅₇₀⁻¹]×R_{NIR} (5)
Car_{red edge}∝[R₅₁₀₋₅₂₀⁻¹−R₆₉₀₋₇₁₀⁻¹]×R_{NIR} (6)

The following exemplifies determining the index for an anthocyanin pigment (Anth), according to FIG. 1. First, the optimal wavelength of λ2 was found using an initial λ₁⁰=530 nm, which is close to the maximum of leaf anthocyanin absorption in acidic alcohols and λ₃⁰=760 nm. RMSE with the (R₅₃₀⁻¹−Rλ2⁻¹)×R₇₆₀ model had minimal values for both dogwood species and maple species at λ₂¹=690-700 nn. In this spectral band reciprocal reflectance is governed mainly by chlorophyll content. The subtraction of R₆₉₀₋₇₀₀⁻¹ from R⁻(λ₁), caused R⁻¹(λ₁)−R⁻¹(λ₂) to be closely related to anthocyanin content. The optimal position of λ₃ in the (R₅₃₀⁻¹−R₆₉₀₋₇₀₀⁻¹)×R_{λ3} model was found in the NIR range beyond 760 nm. The optimal wavelength of λ₁ in the (R_{λ1}⁻¹−R₆₉₀₋₇₀₀⁻¹)×R₇₉₀ model in a wide range around 550 nm. The model for anthocyanin estimation, with NIR range beyond 760 nm, has the form:

Anth∝└R₅₃₀₋₅₇₀⁻¹−R₆₉₀₋₇₁₀⁻¹┘×R_{NIR} (7)

Once a storage device is established providing the optimal wavelengths and calibration parameters, a and b, the apparatus of this invention is used to measure the concentration of pigments in terrestrial systems and marine systems, such as vegetation and bodies of fresh and salt water.

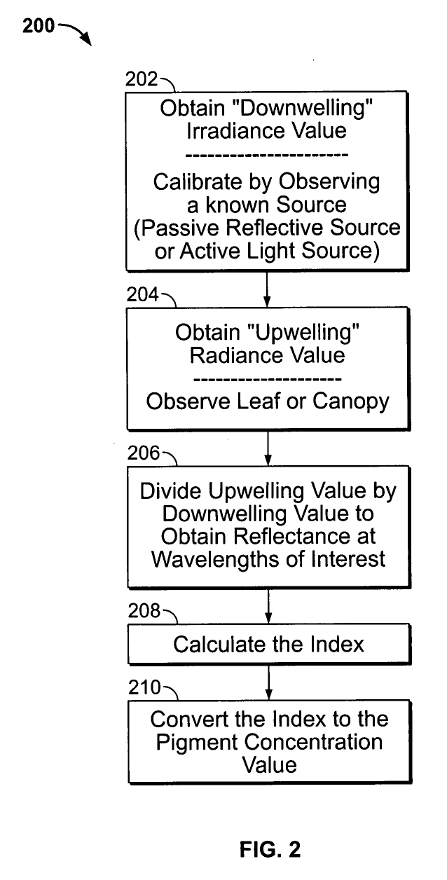

Reflectance is determined at the optimal wavelengths and inserted in the calibrated index equation (2). The value resulting from the calculation is a measure of the concentration of the pigment of interest. FIG. 2 is a flow chart of an embodiment 200 of the measurements of reflectance taken by an apparatus. The apparatus is preferably calibrated, such as by measuring the reflection from a reference surface such as a white piece of paper or plastic with known reflective properties. At step 202, subsequent to calibration, the downwelling brightness value—that is the brightness in a range of wavelengths of light projected onto an object from all directions—is obtained. At step 204, the upwelling brightness value—that is the brightness in range of wavelengths of light coming off the object at a specific angle—is acquired. In this embodiment 200, the downwelling brightness values and upwelling brightness values are obtained and acquired sequentially. At step 206, dividing the upwelling brightness value by the downwelling brightness value provides the reflectance values for each wavelength of interest, or optimal wavelengths. The index is then calculated, at step 208, based on the reflectance values at the first wavelength, second wavelength and third wavelength. At step 210, the index is then correlated by using the calibrating values of a and b to present the concentration of the pigment of interest.

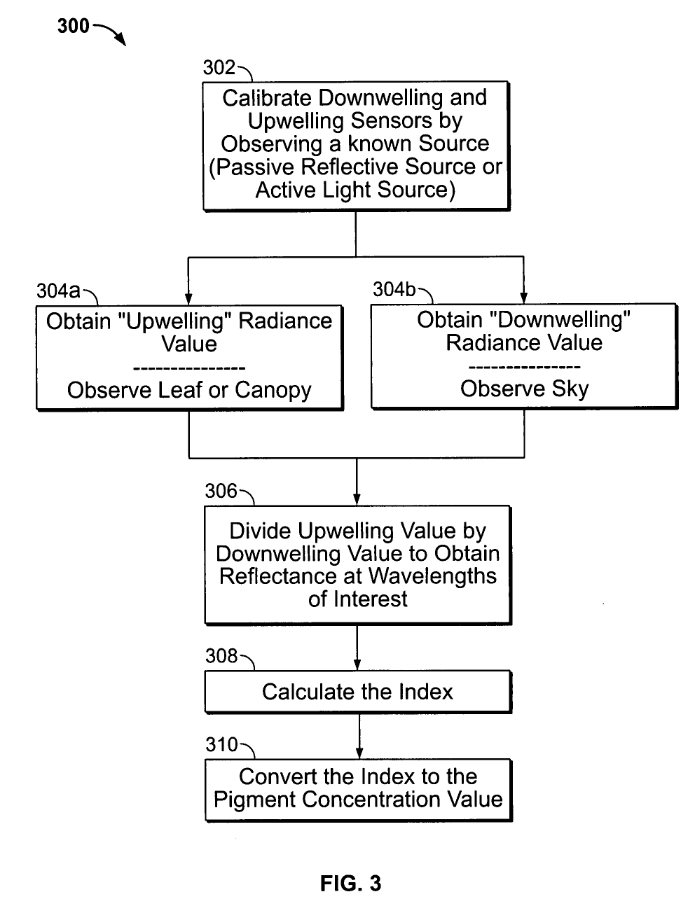

FIG. 3 is a flow chart of an embodiment 300 of the measurements of reflectance taken by an apparatus. At step 302, the apparatus is first calibrated, which may be done by measuring the reflection from a reference surface, such as a white piece of paper. At step 304a and step 304b, the downwelling value and upwelling value are obtained and acquired simultaneously. At step 304a, the upwelling value is acquired via the wavelengths of light coming off the object at a specific angle. At step 304b, the downwelling value is obtained via wavelengths of light projected onto the object at a specific angle. At step 306, dividing the upwelling value by the downwelling value results in values for each wavelength of interest, or optimal wavelengths. The index is then calculated, at step 308, based on the values at the first wavelength, second wavelength and third wavelength. At step 310, the index is then correlated, using the calibration equation values a and b, to the concentration of the pigment of interest.

While the disclosure is susceptible to various modifications and alternative forms, specific exemplary embodiments thereof have been shown by way of example in the drawings and have herein been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

What is claimed is:

1. A method for non-destructive analysis of a plant to determine a physiological and/or phenological condition of the plant through a model value for a pigment of interest, comprising:
measuring a first reflectance from the plant relative to the pigment of interest and a first spectral band;
detecting a second reflectance from the plant relative to additional pigments and a second spectral band;
inverting the first reflectance to produce a first reflectance inverse and the second reflectance to produce a second reflectance inverse;
subtracting the second reflectance inverse from the first reflectance inverse to provide an intermediate result; and
multiplying the intermediate result by the second reflectance to provide the model value for the pigment of interest.

2. A method for determining physiological and/or phenological state of an organism through a model value for a pigment of interest, comprising:
measuring a first reflectance from the organism relative to a pigment of interest and a first spectral band;
detecting a second reflectance from the organism relative to additional pigments and a second spectral band;
identifying a third reflectance from the plant relative to physical or structural characteristics of the organism and a third spectral band;
inverting the first reflectance to produce a first reflectance inverse and the second reflectance to produce a second reflectance inverse;
subtracting the second reflectance inverse from the first reflectance inverse to provide an intermediate result; and
multiplying the intermediate result by the third reflectance to provide the model value for the pigment of interest.

3. A method for analysis of a physiological and/or phenological condition of a plant by simultaneously determining model values for multiple pigments of interest based upon a combination of methods described in claim 1 and claim 2.

4. A method for a determining a physiological and/or phenological condition of a plant comprising:
detecting automatically a first spectral band, wherein said first spectral band has an absorption that is sensitive to a concentration of the pigment of interest;
determining automatically a second spectral band, wherein said second spectral band has an absorption that is sensitive to a concentration of pigments other than the pigment of interest;
subtracting the second spectral band from the first spectral band to obtain a result;
obtaining an index from the result; and
correlating the index to a measurement of the concentration of the pigment of interest.

5. The method of claim 4, further comprising the step of ascertaining automatically a third spectral band, wherein the third spectral band has reflectance differences relative to the first spectral band and the second spectral band.

6. The method of claim 5, wherein said step of ascertaining automatically the third spectral band further comprises multiplying the result by the third spectral band.

7. A close contact instrument for determining one or more concentrations of pigments in an object comprising:
a light source, wherein said light source projects light onto the object;
a sensor, wherein said sensor measures reflectance at optimal wavelengths;
a computational device, wherein said computational device processes the reflectance to obtain an index that correlates to the one or more concentration of a pigment of interest.

8. The close contact instrument of claim 7, further comprising an optical filter.

9. The close contact instrument of claim 7, wherein said computational device further includes a storage device in which values of optimal wavelength, regression coefficients (a) and (b) are retainable for later retrieval and use.

10. The close contact instrument of claim 9, wherein said storage device further retains for later retrieval and use an identity of the object for each of the values of optimal wavelength, regression coefficients (a) and (b).

11. A method for non-destructive analysis of a plant to determine a physiological and/or phenological condition of the plant through a model value for a pigment of interest, comprising:
measuring a reflectance at a first wavelength or a first waveband from the plant relative to a concentration of the pigment of interest and relative to a masking effect of the characteristics of all other pigments;
detecting a second reflectance at a second wavelength or a second waveband from the plant relative to the masking effect of all other pigments but not to the concentration of the pigment of interest;
inverting the first reflectance to produce a first reflectance inverse and the second reflectance to produce a second reflectance inverse;
subtracting the second reflectance inverse from the first reflectance inverse to provide an intermediate result; and
multiplying the intermediate result by a third reflectance, which determines and corrects for the effect of certain physical plant or object characteristics to provide the model value for the pigment of interest.
